(19) United States
(12) Patent Application Publication
(10) Pub. No.: US 2003/0049508 A1
(43) Pub. Date: Mar. 13, 2003

(54) Metal gas batteries

(76) Inventors: Alexander M. Iarochenko, Toronto (CA); Evgeny B. Kulakov, Toronto (CA)

Correspondence Address: MANELLI DENISON & SELTER, 2000 M STREET NW SUITE 700, WASHINGTON, DC, 20036-3307, US

(21) Appl. No.: 09/947,698

(22) Filed: Sep. 7, 2001

(51) Int. Cl. H01M 4/86; H01M 12/06

(52) U.S. Cl. 429/27; 429/41; 429/42

(57) ABSTRACT

An improved gas-diffusion cathode for use in an electrochemical cell comprising an electrically conductive cathode member having a first side communicable with an aqueous electrolyte and a second side communicable with a gaseous medium; and a water-impermeable membrane adjacent said cathode member second side to reduce passage of liquid water between said cathode member and said gaseous medium and having a membrane first side and a membrane second side wherein said membrane first side faces said cathode member and wherein said water-impermeable membrane comprises one or more portions defining one or more openable and closeable apertures the improvement wherein said apertures are associated with one or more integrally-formed resiliently flexible flaps on said membrane first side to effect said opening and closing. The batteries have reduced unwanted water vapour ingress and egress characteristics in its no-load mode.

### FIELD OF THE INVENTION

This invention relates to metal-gas electrochemical cells, batteries and fuel cells, particular metal-air batteries suitable for portable electronic devices, and more particularly to air-diffusion cathodes for use in said batteries.

### BACKGROUND TO THE INVENTION

Metal-air cells rely on an air cathode that allows oxygen from the air to contact and react with the active catalytic surfaces of the electrode and be converted to hydroxide. In this manner, the cathode becomes a consumer or “sink” for electrons. The source for electrons in a fuel cell or battery can be any oxidation reaction such as metal dissolution or hydrogen conversion to hydrogen ions. These electron source reactions occur at the anode of the cell.

The cathode reaction involving oxygen is a complex reaction requiring oxygen gas to have contact with the electrolyte so that the conversion with water to the hydroxide ion can take place. Furthermore there must be a conductive element near this reaction site so that the electrons provided by the anode reaction can transferred to the oxygen and water molecules in order to form hydroxide ions. An efficient cathode is, thus, a structure which allows gas, liquid and conductive solid to be in contact. The cathode must further prevent liquid electrolyte, which is necessary for completion of the electronic circuit, from leaking through the cathode structure and either flooding the pore space and preventing ready uptake of oxygen or escaping from the cell. The cathode is, thus, constructed with hydrophilic materials on the inside to allow electrolyte wetting and with hydrophobic materials on the outside to allow oxygen gas to enter the structure but prevent electrolyte escape. Despite the good barrier properties of the hydrophobic materials for liquid electrolyte, the materials cannot prevent water vapor from ingress or egress to the cell because water vapor is a gas with similar properties to oxygen. There is a natural equilibrium between water in the electrolyte and water vapor which depends on temperature and electrolyte composition. As temperature increases, the humidity increases. While electrolyte concentration increases, humidity decreases. Thus, in a low humidity environment, water will evaporate from the electrolyte to the air. In a high humidity environment, water vapor will pass to the electrolyte. This transport of water between the electrolyte in the cell and the atmosphere results in reduced cell life. If too much water enters the cell, the cathode can become flooded and poor oxygen transport occurs, which decreases the power of the cell dramatically. If water leaves the cell because of low outside humidity then evaporation of water from the electrolyte occurs which dries out the cell and diminishes the power of the cell, dramatically. Control of the water balance of the fuel cell or battery is, thus, very dependent on ambient conditions, outside of the cell which are not, generally, controlled.

There have been several approaches to controlling the water balance in the cell. The most direct is to cover the cathode with a semi permeable permeation layer. Thus air, oxygen and water vapor can only be transported slowly to or from the cell. This approach is described in U.S. Pat. No. 3,902,922 issued Sep. 2, 1975, wherein a continuous polymeric coating covering the cathode is used to reduce the rate of transport of gaseous species to the cell. Water transport is thus restricted.0 U.S. Pat. No. 4,189,526, issued Feb. 19, 1990, describes the use of an oxygen diffusivity-limiting membrane such as sintered poytetrafluoroethylene which limits oxygen transport and other species such as water and carbon dioxide and extends the life of the cell. U.S. Pat. No. 5,985,475, issued Nov. 16, 1999 describes the use of a selectively permeable membrane which favors oxygen transport over that of water vapor. A 3:1 ratio of oxygen transport to water vapor transport is claimed. The oxygen transport claimed was 1×10⁻⁷ cms⁻¹ cmHg⁻¹.

However, a significant disadvantage of these approaches is that oxygen transport, notwithstanding the selectivity, is reduced. The lower rate of oxygen transport reduces the rate of oxygen conversion and, thus, directly limits the power output from the cell.

Similar approaches have been taken using physical barriers. U.S. Pat. No. 4,118,544, issued Oct. 3, 1978, describes the use of an impermeable membrane which has holes to allow limited passage of oxygen and water vapor to the cathode. The holes can be sized to give the appropriate oxygen transport requirements for the power density of the cell. However, the holes are permanent structures and allow ingress or egress of water vapor on a continuous basis.

Significant improvements on the simple restricted cathode access have been described in the literature. These involve providing access ports or tubes that can be electronically or mechanically opened only when needed. U.S. Pat. No. 4,177,327 issued Dec. 4, 1979, describes an electrically operated air access vent cover. U.S. Pat. No. 4,262,062 issued Apr. 14, 1981, describes the use of an internal valve to admit more oxygen during times of high power demand on the cell. U.S. Pat. No. 4,729,930 issued Mar. 8, 1988, describes the use of a quick acting solenoid valve which opens to allow temporary greater air access to the cell. U.S. Pat. No. 5,069,986 issued Dec. 3, 1991, describes the use of a mechanically removable tape to expose more access ports for oxygen ingress to the cathode. With the tape in place, oxygen and other species such as water and carbon dioxide are prevented from entering the cell. U.S. Pat. No. 5,191,274 issued Mar. 2, 1993, describes the use of multiple supply holes in a cell casing which can be opened to provide oxygen ingress. While the holes are closed, neither water vapor nor oxygen can be exchanged with the environment. U.S. Pat. No. 5,652,068 issued Jul. 29, 1997, describes the use of tubes which connect the air cathode compartment to the environment. These tubes can be closed or opened and serve a variety of functions of which restricting or permitting access of oxygen and water vapor is one feature. A significant disadvantage of these systems is their complexity and reliance on either external mechanical power or internal or external electrical power to open or close the access ports.

Another advance on control of air access and water restriction has been the active control of airflow to the cathode. In this type of system, rather than rely on simple diffusion or migration of air through the restrictions, which limit power output, a fan is used to move the air through the restrictions during times of power demand. The movement of air during power demand times also can help provide cooling for the cell. Nevertheless, a significant feature of these systems is that during the times of non-power demand, the cathode has restricted access to air and, hence, limited access to water exchange between electrolyte and the environment. U.S. Pat. Nos. 5,571,630 issued Nov. 5, 1996, and 5,387,477 issued Feb. 7, 1995, describe a cell with restricted cathode and air circulation system for cooling and cathode air supply. U.S. Pat. No. 5,560,999 issued Oct. 1, 1996, describes a restricted air circulation system minimizing the amount of ambient air needed U.S. Pat. Nos. 5,356,729 issued Oct. 18, 1994; 5,354,625 issued Oct. 11, 1994; and 5,691,074 issued Nov. 25, 1997 describe a restricted air cathode compartment which can be provided with air during power demand times by an external fan. U.S. Pat. No. 6,248,464 issued Jun. 19, 2001 describes a method of restricting access to the cathode by means of hollow needles which can open or close a septum. An air moving device can optionally be used to enhance movement through the hollow needles. U.S. Pat. No. 6,235,418 issued May 22, 2001 describes cell stack shell which is oxygen permeable and water impermeable. The shell has a number of holes or a plenum for allowing air ingress and, optionally, an air mover system for increasing oxygen transport.

The disadvantage of the aforesaid devices described is that there must be active management of the vents or access ports during power demand. The vents must be opened during power demand and closed during time of non power demand. For those systems with continuously open ports, vents or tubes, if the oxygen access is large and sufficient to satisfy power demand then there will be a correspondingly large water vapor exchange opportunity. If the opening access is small, then during power demand some form of air movement system is required to force oxygen through the constricted access. Active air management systems require control systems and electrical or mechanical power.

There is, therefore, a need for improved electrochemical cells, batteries and fuel cells which do not suffer from the aforesaid disadvantages.

### SUMMARY OF THE INVENTION

It is, therefore, an object of the present invention to provide an improved gas-diffusion cathode which has reduced unwanted water vapor ingress and egress characteristics in its no-load mode.

It is a further object to provide electrochemical cells, batteries and fuel cells comprising said improved gas-diffusion cathode.

Accordingly, in one aspect, the invention provides an improved gas-diffusion cathode for use in an electrochemical cell, comprising an electrically conductive cathode member having a first side communicable with an aqueous electrolyte and a second side communicable with a gaseous medium; and a water-impermeable membrane adjacent said cathode member second side to reduce passage of liquid water between said cathode member and said gaseous medium and having a membrane first side and a membrane second side wherein said membrane first side faces said cathode member and wherein said water-impermeable membrane comprises one or more portions defining one or more openable and closeable apertures the improvement wherein said apertures are associated with one or more integrally-formed resiliently flexible flaps on said membrane first side to effect said opening and closing.

By the term “water impermeable membrane” in this specification is meant a membrane that does not allow of the passage of liquid water therethrough.

Most preferably, the membrane is also impermeable to the passage of water vapour.

Thus, the essence of the present invention resides in the presence of a water impermeable membrane formed of a resiliently flexible material in the form of a film, foil, sheet or the like having at least one, and more preferably, a plurality of apertures, such as perforations and holes of any suitable size and shape, each having an associated portion of membrane in the form of an integral flap which, in its “natural” state, resides or rests adjacent its aperture as to effectively block or close the aperture as a seal to water ingress or egress through the membrane. In contrast, under load, the cathode takes up the gas e.g. oxygen, to effect a reduction in the air pressure adjacent the cathode to cause a pressure differential with the ambient air and cause the flaps covering the apertures to open to allow air passage to the cathode member, against the resilience of the flexible membrane. When the electrical load is removed, the resilience causes the flaps to return to its aforesaid natural state adjacent and covering the apertures to prevent ingress and egress of water as liquid and vapour, through the membrane.

The numbers, sizes and shapes of the apertures or perforations can be as desired to achieve the aforesaid desired objective. For example, there may be a plurality of round, square, half-moon and the like shaped apertures of a sectional area of about 0.1-0.3 cm² at a concentration of one per 1-10 cm² membrane.

The flexible membrane may be formed of any suitable resiliently flexible material in the form of a film, foil, sheet and the like, formed of, for example, a plastics or metallic material of sufficient thickness, e.g. 0.05-1 mm, to exploit its resilient flexibility in the practise of the invention. Typical metallic materials, for example, are aluminum, nickel, copper, steel, gold and silver. Typical plastics materials, for example, are polyolefins, such as for example, the polyethylenes, polypropylenes, polybutadiene family of olefin polymers and copolymers with vinyl acetate, acrylic acid, acrylates, butene, pentene, hexene and octene; fluoropolymers, such as Teflon®, fluoro polyethylene and nylons.

In a most preferred feature, the membrane has dark, preferably, black surfaces to enhance heat dissipation therethrough and therefrom the cell to its ambient surroundings.

To also enhance heat dissipation from the cell, the membrane may be suitably located away from the air cathode, for example, on the casing adjacent the casing air inlet, provided the principle of the invention as hereinbefore described is achieved.

The gas-diffusion cathodes as hereinbefore defined are of particular use as air cathodes in electrochemical cells, batteries and fuel cells in providing minimal unwanted water transfer to and from the electrolyte therein to its ambient surroundings.

Accordingly, in a further aspect, the invention provides a metal-air battery comprising an air-diffusion cathode comprising an electrically conductive cathode member having a first side and a second side communicable with an air medium; and a water-impermeable membrane adjacent said cathode member second side to reduce passage of liquid water between said cathode member and said air medium and having a membrane first side and a membrane second side wherein said membrane first side faces said cathode member and wherein said water-impermeable membrane comprises one or more portions defining one or more openable and closeable apertures the improvement wherein said apertures are associated with one or more integrally-formed resiliently flexible flaps on said membrane first side to effect said opening and closing;

a metal anode;

an electrolyte in contact with said anode and said first side of said cathode member; and

a housing to contain said cathode, said anode and said electrolyte.

The gas-diffusion cathodes and electrochemical cells as hereinbefore defined provide a number of advantages over the prior art devices.

The invention batteries do not require (i) valves, plates and tubes; (ii) mechanical moving parts; and (iii) power to manage the air cathode oxygen supply.

In alternative embodiments, the resiliently flexible membrane may be disposed a distance from the cathode member, for example, suitably affixed to the casing of a battery or cell while capable of providing the opening and closing functions as hereinbefore described.

Thus, the invention requires only the additional feature of a suitable and inexpensive thin barrier film, disposed relative to the cathode per se as hereinbefore defined. The flaps to restrict water exchange between the electrolyte and the environment are normally closed and open only when air is drawn into the cathode compartment during power demand. During this time, air flow into the cathode compartment opposes any water vapor escape into the environment.

Thus, the air-cathodes, according to the present invention, are most suitable for different types of batteries and electrochemical cells, such as, for example, batteries for use in miniature portable electronic devices such as cell phones, watches, hearing aids and the like.

### BRIEF DESCRIPTION OF THE DRAWINGS

In order that the invention may be better understood, preferred embodiments will now be described by way of example only with reference to the accompanying drawings, wherein

FIG. 1 is a diagrammatic, partly disassembled, perspective view of a battery cartridge having a resiliently flexible membrane with integrally formed flaps according to the invention in association with a converter.

FIGS. 2A and 2B are diagrammatic cross-sectional views, in part, of a cell according to the invention with components separated for better viewing, in, respective, under-load and no-load modes;

FIG. 3 is a diagrammatic cross-sectional views, in part, of a cell according to the invention with components separated for better viewing, with the flexible membrane adjacent a housing wall;

FIG. 4 shows a diagrammatic perspective view of a zinc-air battery according to the invention.

FIGS. 5 and 6 are graphs each showing a comparison of the water loss over time in a standby mode between embodiments with and without a membrane of use in the invention in an aluminum air cell;

FIG. 7 is a graph of the current-voltage characteristics of an aluminum air cell with and without an integrally formed impermeable membrane according to the prior art;

FIG. 8 is a graph of the power output over time of an aluminum air cell with an integrally formed impermeable membrane according to the invention during a 2 A discharge;

FIG. 9 is a graph showing voltage over time for an aluminum air cell according to the invention; and wherein the same numerals denote like parts.

### DETAILED DESCRIPTION OF PREFERRED EMBODIMENTS

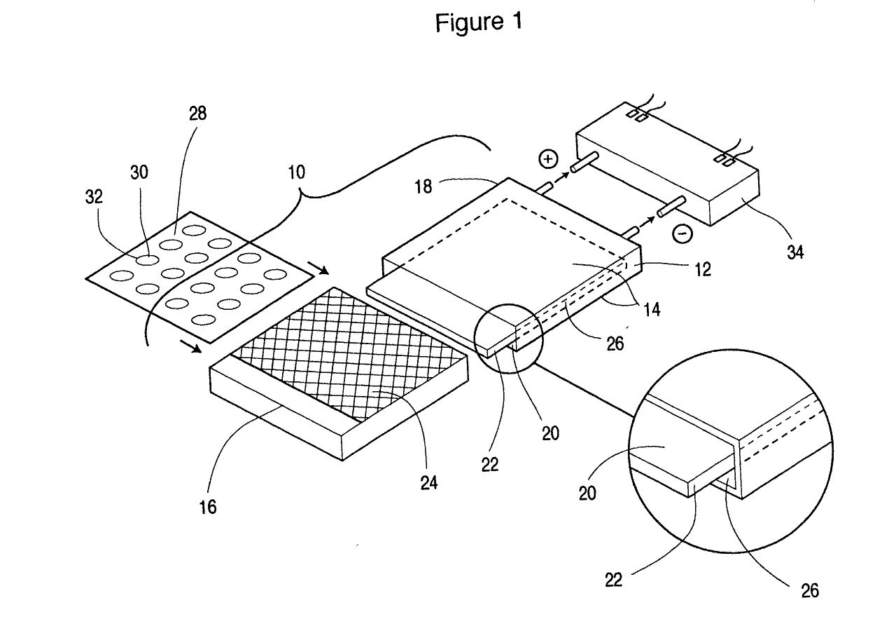

With reference to FIG. 1, this shows generally as 10 a battery cartridge as a perspective, two halved exploded view. Cartridge 10 has a plastic housing 12 having side walls 14 and end portions 16, 18 which define an electrolyte chamber 20. Chamber 20 contains a rectangularly-shaped aluminum anode plate 22, adjacent an air diffusion nickel mesh cathode 24 in an air cavity 26. Cathode 24 is described in more detail, hereinbelow.

Adjacent cathode 24 is a resiliently flexible polyethylene membrane 28 having a plurality of apertures 30, each associated with an integrally formed flap 32. Cartridge 10 is shown with an associated converter 34.

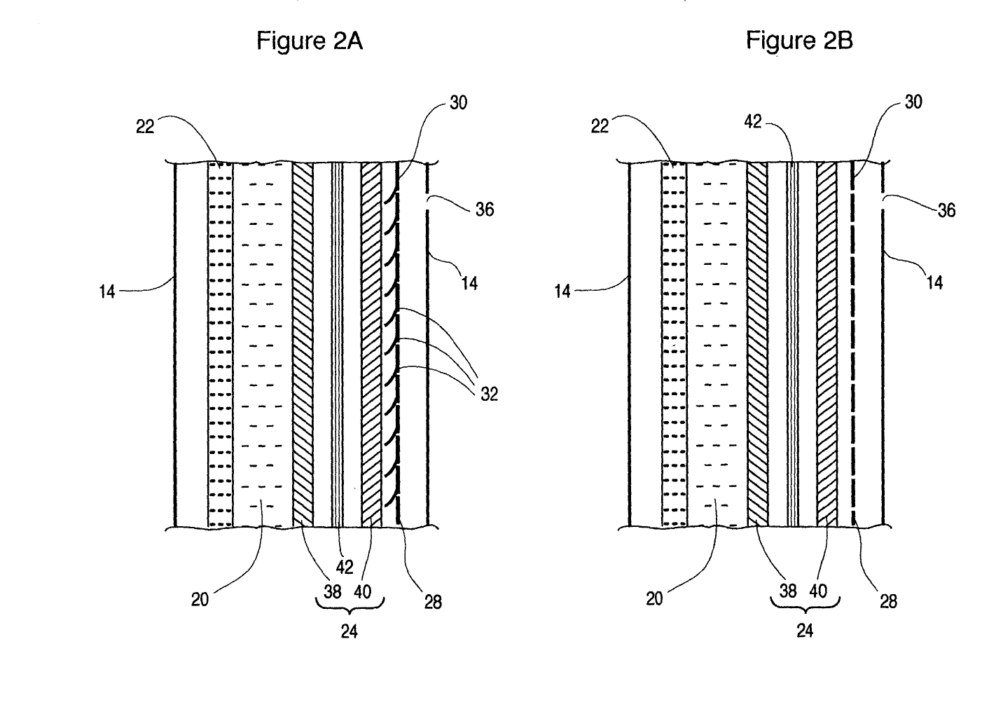

With reference now to FIGS. 2A and 2B, these show battery 10 having anode 22, electrolyte chamber 20, and housing 12 with one side 14 having an aperture 36 to allow air to pass from outside housing 12 to adjacent cathode 24.

In more detail, air-diffusion cathode 24 consists of a planar member 38 formed of a hydrophilic material having one side in communication with electrolyte chamber 20, facing anode plate 22, a planar member 40 formed of a hydrophobic material having one side in communication with air medium 26 and a nickel mesh cathode member 42 sandwiched between hydrophilic member 38 and hydrophobic member 40.

FIG. 2A shows flaps 32 blown away from their respective apertures 30 when cell 10 is, operationally, under load and drawing air to cathode 24 through aperture 36.

FIG. 2B shows membrane 28 when cell 10 is not under load in a stored pre-use or subsequent use standby mode, such that the resilient flexibility of the polyethylene causes each of flaps 32 to return to their natural configuration adjacent and blocking its respective aperture 30, to prevent ingress and egress of water vapor and air through membrane 28 to cathode 24.

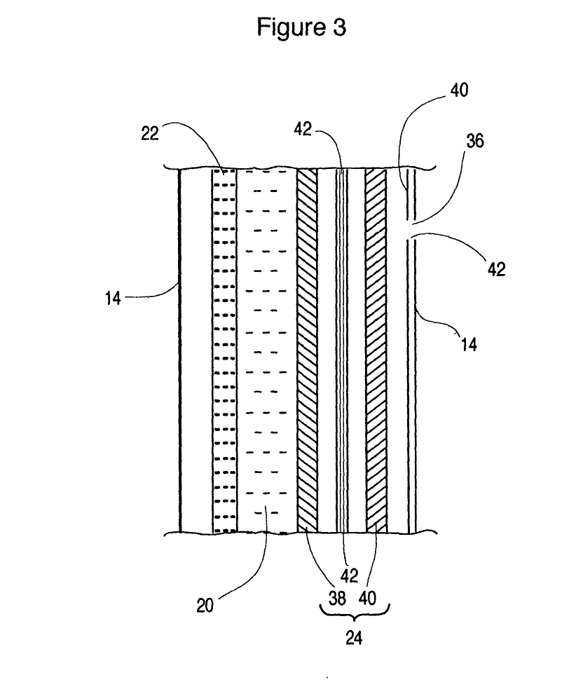

FIG. 3 shows a polyethylene membrane 40 having a single aperture 42 with an integrally formed flap 44 adjacent to wall 14 wherein flap 44 is located as to seal housing aperture 36 when the cell is in a non-load, standby mode, but opens under load as hereinbefore described.

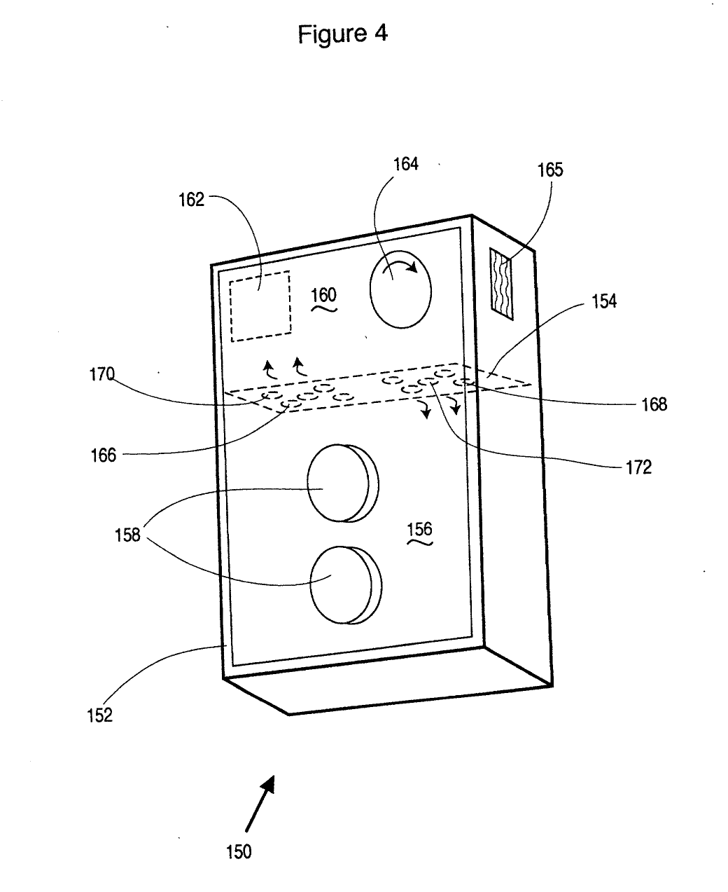

With reference to FIG. 4, this shows generally as 150, a zinc-air battery for a portable cell phone (not shown). Battery 150 has a 10 cm long×5 cm wide×1.5 cm deep casing 152 formed of a rigid plastics material divided by a flexible membrane 154 into a cell compartment 156 having a plurality of individual zinc air cells 158; and an electronics compartment containing a circuit board 162 and a centrifugal air fan 164. Casing 152 has an air inlet grill 165.

Membrane 154 has two series of resiliently flexible flaps 166 and 168 which cover a respective plurality of apertures 170, 172, and which are openable under the influence of fan 164 in the following manner. Flaps 166 are integral with membrane 154 on the side inner of compartment 160 while flaps 168 are integral with membrane 154 on the side outer of compartment 160.

Thus, in operation, activation of fan 164 causes air to be pulled into compartment 160 blown through apertures 172 to feed oxygen to the air cathodes in compartment 156, through grill 165 and, thereafter, back into compartment 160 through aperture 170. Stopping fan 162 causes all of apertures 170 and 172 to be sealed under the resilience of each of flaps 166 and 168.

Thus, by virtue of air movement into cell compartment 160, the air pressure rises therein and causes the membrane flaps 166 to open outward into electronics compartment 160. In this manner, membrane 154 allows air into and, thus, oxygen circulation through the cell compartment and across air cathodes 158. When there is no load for the zinc air cell battery, fan 164 is not activated and there is no pressure differential between cell compartment 156 and electronics compartment 160 so that all of the membrane flaps remain closed and no air or water vapor is transported into or out of the zinc air battery. FIG. 4, thus, demonstrates a dual action membrane which can open both inward and outward, simultaneously, when desired to allow air circulation. The advantage of the design shown in FIG. 4 is that a long diffusion air path connecting fan 164 to the zinc air cell modules 158 and a corresponding long diffusion path air way path connecting these to electronics compartment 160 is not required. Without the need for two air way paths, there is more space in the compartment for larger cells, or, conversely, the cell compartment may be made smaller.

It will be readily understood that resiliently flexible membrane and flaps suitably disposed in other convenient locations are possible, for example, on the battery casing.

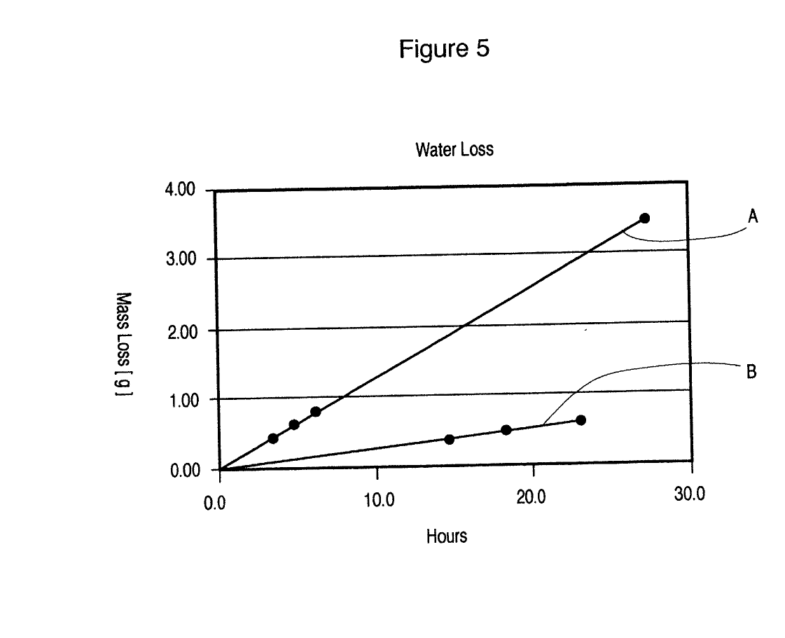

FIG. 5 demonstrates the reduction of water evaporation by use of a resiliently flexible membrane according to the invention. A graph of the results of data from Example 1 wherein line A is an embodiment without the membrane and line B is according to the invention, shows that water loss was reduced by 76% over a 24 hour test period.

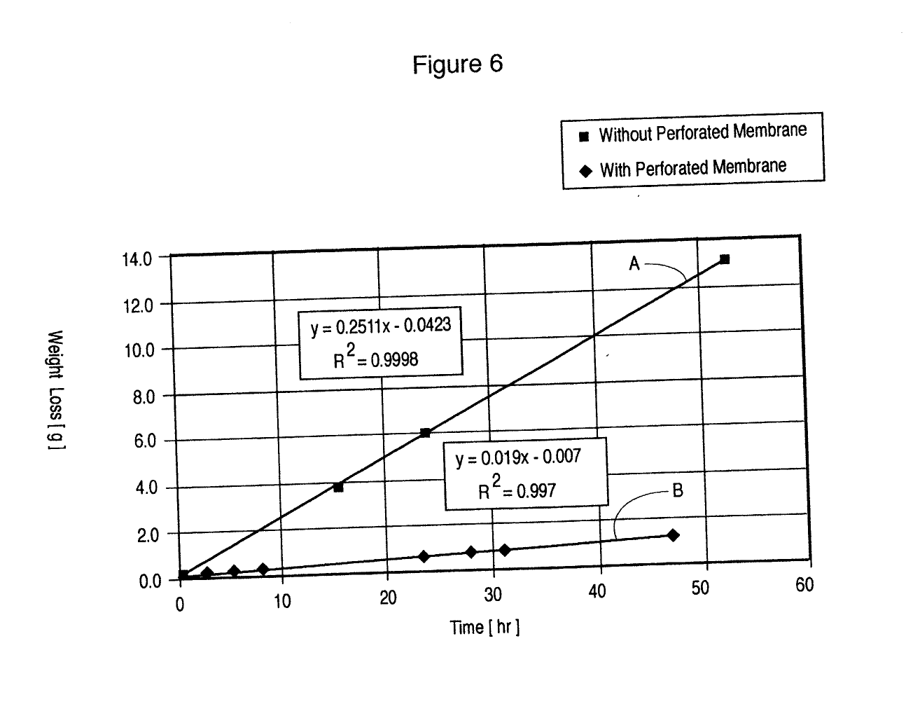

FIG. 6 demonstrates the reduction of water evaporation by use of a resiliently flexible membrane according to the invention. A graph of the results of data from Example 2 wherein line A is an embodiment without the membrane and line B is according to the invention, shows that water loss was reduced by 92% over a 48 hour test period.

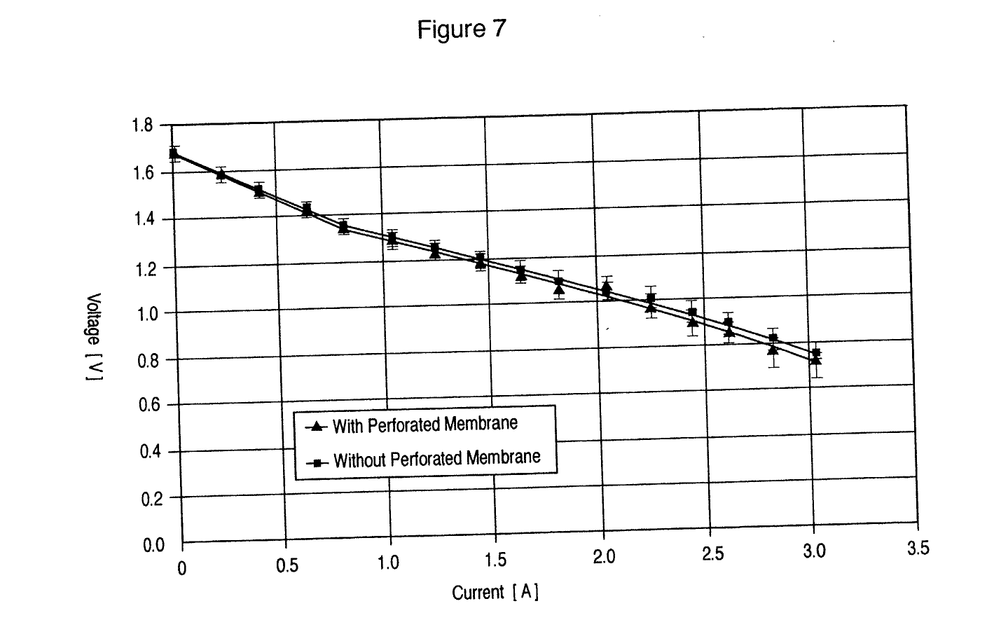

FIG. 7 demonstrates the volt-ampere characteristics of an aluminum air cell with and without a resilient flexible membrane as a graph of the results from Example 3 in which an aluminum air cell was discharged at a variety of currents and the steady state voltage of the cell was recorded. The results show that the membrane does not limit the power (volts times current) of the cell. Data points indicate the voltage values at steady state. Measurements began at open circuit and were stepped in 0.2A increments to 3 amps. Two such experiments were conducted. One experiment had an integrally formed impermeable membrane with resilient apertures labeled “with perforated membrane” The other experiment had the same cell tested without the integrally formed impermeable membrane with resilient apertures. The results are labeled as “without perforated membrane”. The variation of the steady state voltage readings are shown as error bars at each current value. The results show that there is no significant difference in performance in the two cases.

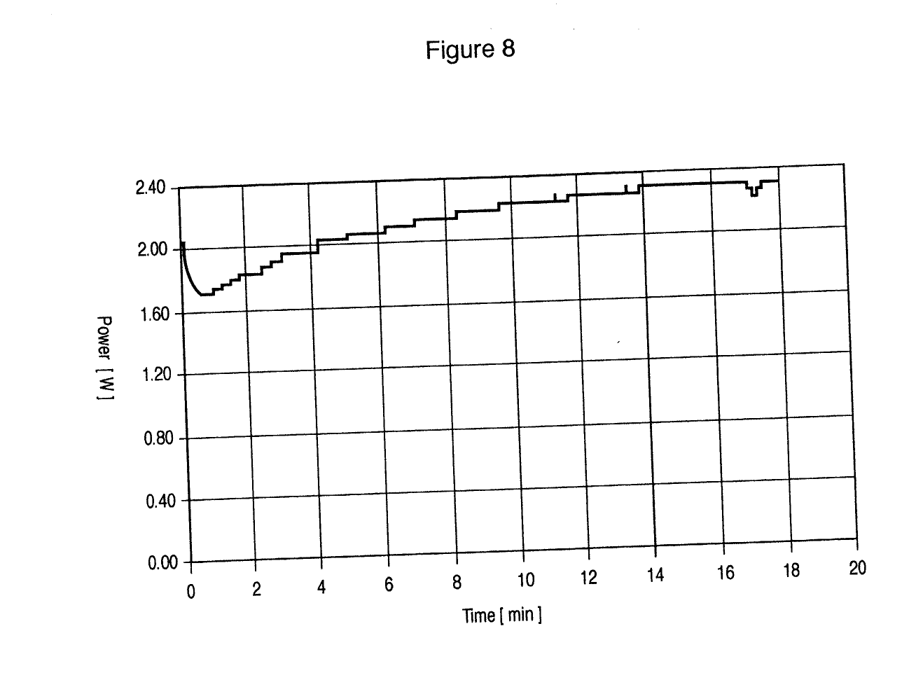

FIG. 8 shows the power characteristics as watts versus time for a 2 ampere discharge of an aluminum air cell with a resilient flexible membrane cover as a graph of the results from Example 4 in which an aluminum air cell has a resilient flexible membrane cover.

FIG. 8 shows the power characteristic in watts of an aluminum cell being discharged at a constant 2 amp current. The cell was equipped with the integrally formed impermeable membrane with resilient flaps hereinbefore described. It can be seen that the power characteristic stabilized after about 12 minutes, which is typical for an aluminum cell of this type. The discharge clearly does not show any oxygen starvation, since there was no decrease in the power output with time and shows that the resilient flaps are allowing sufficient oxygen ingress to the cell for normal under load operation. This cell was operated in a passive mode with no external fan or air moving device to force oxygen to the air cathode surface.”

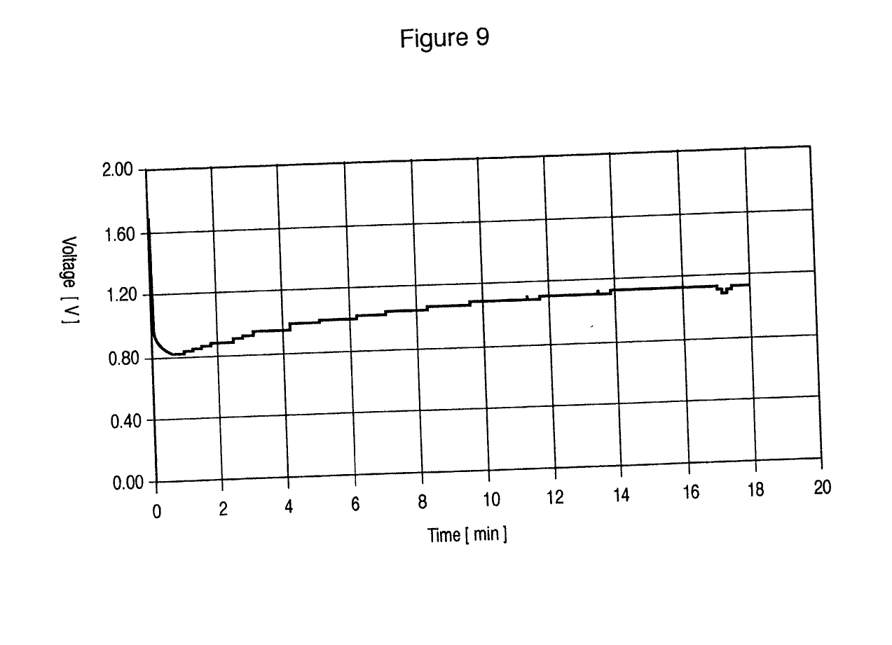

With reference to FIG. 9, this is as for FIG. 8, except that the power axis has been replaced with voltage

### EXAMPLE 1

This example demonstrates that the resiliently flexible membrane can be used to cover an air cathode and significantly decrease water evaporation.

An aluminum air battery of external dimensions 72.2 mm in height, 37.3 mm in width, and 12.0 mm in depth was placed in a drying oven at 60° C. for one hour to ensure complete dryness. The cell comprised two air cathodes in parallel arrangement with a pair of solid aluminum-alloy anodes inserted equidistantly from the cathodes.

A graduated syringe was used to fill the cell initially with 14 ml of distilled water through delivery ports located on top of the cell between the anode and cathode leads. Closing screws were then tightened to ensure that no water evaporated from the ports. The cell was placed inside a 2 L desiccator in an upright position. A concentrated sulfuric acid solution was used inside the desiccator for the purpose of fixing the relative humidity level inside the desiccator between 10 and 20%. The surface temperature of the cartridge cell was 24+/−3° C. throughout the duration of the test. The weight of the filled cell was recorded initially (within 10 mg accuracy). Subsequent weight measurements were taken at pre-determined time intervals over a total period of 46 hrs. The weight loss was used to estimate the total evaporation rate of the water through the cathodes.

The above experiment was repeated for a cell cartridge which both cathodes were wrapped with a perforated transparent Teflon membrane (Dupont PFA 100-LP) as illustrated in FIG. 1. The dehydrated cell was initially filled with 15 ml of distilled water, placed in an upright position inside the desiccator containing concentrated sulfuric acid as mentioned above. The surface temperature of the cartridge cell was 22+/−1° C. throughout the duration of the test. The weight of the filled cell was recorded initially (within 10 mg accuracy). Subsequent weight measurements were taken at pre-determined time intervals over a total period of 24 hrs. The weight loss was used to estimate the total evaporation rate of the water through the cathodes and through the ceramic re-combiner.

The results given in FIG. 5 indicate that, under these testing conditions, the addition of a perforated membrane reduces water evaporation by 76%.

### EXAMPLE 2

Another test was conducted to show the effectiveness of the resilient flexible membrane in preventing water evaporation from metal air cell according to the invention as used in Example 1.

A graduated syringe was used to fill the cell initially with 14 ml of distilled water through the delivery ports located on top of the cell between the anode and cathode leads. The closing screws were then tightened to ensure that no water evaporated from the ports. The cell was placed in a upright position and remained under room conditions throughout the duration of the test, namely at 1+/−0.02 atm pressure, 30+/−3° C. temperature, and 67+/−5% relative humidity. The weight of the filled cell was recorded initially (within 10 mg accuracy). Subsequent weight measurements were taken at pre-determined time intervals over a total period of 52 hrs. The weight loss was used to estimate the total evaporation rate of the water through the cathodes.

The above experiment was repeated for a cell cartridge in which both cathodes were wrapped with a perforated transparent Teflon membrane (Dupont PFA 100-LP) as illustrated in FIG. 1.. As before, the dehydrated cell was initially filled with 15 ml of distilled water, placed in an upright position, and remained under room conditions throughout the duration of the test. These conditions were 1 +/−0.02 atm, 20+/−1° C. temperature, and 89+/−5% relative humidity. Subsequent weight measurements were taken at pre-determined time intervals over a total period of 48 hrs. The weight loss was used to estimate the total evaporation of the water through the cathodes.

The results are shown in FIG. 6 and demonstrate that under these testing conditions, the use of a resilient flexible membrane affixed to the outside surface of an aluminum—air cell reduces water evaporation by 92% over a 48 hour test. The water loss rates both with and without the membrane can be seen to be linear with time. Linear regression lines were fitted to both data sets with a regression coefficient (R²) of greater than 0.99 indicating a good linear fit.

### EXAMPLE 3

An aluminum air cell as described in Example 1 and Example 2 was filled with 15 mL of 4 molar potassium hydroxide electrolyte. The cell was then connected to an electronic load in which the discharge current could be set. 16 different discharge current values were used ranging from 0 to 3 Amperes. At each discharge current, beginning with 0 amperes and increasing in units to 3 amperes, the steady state voltage would be recorded. Usually a constant voltage would be obtained within 1 minute of voltage measurement. The variation of voltage at the steady state value would be obtained by recording 3 separate voltage values. The data is plotted in FIG. 7 with the error bars for each measurement. A line is drawn through the data to show the data trend. As the discharge current is increased the voltage of the cell decreased. The same cell was then wrapped with the resilient flexible membrane and the same set of discharge current measurements taken. The data is also plotted in FIG. 7. It can be seen from the two data sets, one with the membrane present and the other without the membrane present, that the current voltage characteristics are the same. The error bars in the voltage data overlap showing that there is no significant difference in the two data sets. Thus the presence of the resilient flexible membrane does not affect the performance of the cell. It might have been anticipated that if water vapor loss was reduced by the presence of the membrane, then the membrane might also reduce the oxygen or air access to the cathode surface. The data clearly shows that this reduction is insignificant.

### EXAMPLE 4

The performance of a metal air cell can change with time for a number of reasons including loss or consumption of electrolyte. In this test the same aluminum air cell was discharged at a constant 2 ampere rate with a resiliently flexible membrane cover. The same type of cell as describe in Example 1 and 2 was filled with 15 mL of 4 M caustic electrolyte. The cell was again connected to the electronic load and was discharged at a constant 2 amperes with the voltage versus time being recorded. The data were plotted as power (volts times current) versus time and are shown as FIGS. 8 and 9. The cell has a high power output which then drops to a lower value within the first minute of discharge before recovering to a steady state value. This characteristic is typical for this type of cell. The membrane cover with flaps clearly allows the cell to operate and discharge as demonstrated by the data in FIGS. 8 and 9.

Although this disclosure had described and illustrated certain preferred embodiments of the invention, it is to be understood that the invention is not restricted to these particular embodiments. Rather, the invention includes all embodiments that are functional or mechanical equivalents of the specific embodiment and features that have been described and illustrated.

1. An improved gas-diffusion cathode for use in an electrochemical cell comprising:
an electrically conductive cathode member having a first side communicable with an aqueous electrolyte and a second side communicable with a gaseous medium; and
a water-impermeable membrane adjacent said cathode member second side to reduce passage of liquid water between said cathode member and said gaseous medium and having a membrane first side and a membrane second side, wherein said membrane first side faces said cathode member, and wherein said water-impermeable membrane comprises one or more portions defining one or more openable and closeable apertures, the improvement wherein said apertures are associated with one or more integrally-formed resiliently flexible flaps on said membrane first side to effect said opening and closing.

2. A cathode as defined in claim 1 wherein said water impermeable membrane is water vapor and liquid water impermeable.

3. A cathode as defined in claim 1 comprising a plurality of said membrane portions.

4. A cathode as defined in claim 1 wherein said water impermeable membrane is formed of a thermoplastics material.

5. A cathode as defined in claim 4 wherein said thermoplastic material is selected from the group consisting of a polyolefin, fluoropolymer and nylon.

6. A cathode as defined in claim 1 wherein said water impermeable membrane is a foil formed of a metal.

7. A cathode as defined in claim 6 wherein said metal comprises a metal selected from aluminum, zinc, nickel, copper, silver and gold.

8. A cathode as defined in claim 1 further comprising a hydrophilic layer adjacent said first side of said cathode member.

9. A cathode as defined in claim 1, wherein said cathode membrane comprises a carbon/metal conductor.

10. A cathode as defined in claim 9, wherein said metal conductor comprises a nickel mesh.

11. A cathode as defined in claim 1 wherein said resiliently flexible material is black.

12. A battery comprising a gas diffusion cathode as defined in claim 1.

13. A battery comprising an air-diffusion cathode comprising an electrically conductive cathode member having a first side and a second side communicable with an air medium; and a water-impermeable membrane adjacent said cathode member second side to reduce passage of liquid water between said cathode member and said air medium and having a membrane first side and a membrane second side wherein said membrane first side faces said cathode member and wherein said water-impermeable membrane comprises one or more portions defining one or more openable and closeable apertures the improvement wherein said apertures are associated with one or more integrally-formed resiliently flexible flaps on said membrane first side to effect said opening and closing;
a metal anode;
an electrolyte in contact with said anode and said first side of said cathode member; and
a housing to contain said cathode, said anode and said electrolyte.

14. An electrochemical cell as defined in claim 13 wherein said housing has a portion defining an aperture constituting an air passage through said housing connecting the inside and said outside of said housing and wherein said resiliently flexible membrane is adjacent said aperture to effect sealing or opening of said aperture.

15. A battery as defined in claim 13 wherein said electrolyte is about 25% to about 50% W/W potassium hydroxide solution.

16. A battery as defined in claim 13, wherein said anode is a metal selected from the group consisting of zinc, iron, cadmium, copper and aluminum.

17. A battery as defined in claim 13 further comprising an air fan.
